(19) United States
(12) Patent Application Publication
(10) Pub. No.: US 2026/0220560 A1
(43) Pub. Date: Jul. 30, 2026

(54) MODEL GENERATION SUPPORT SYSTEM, MODEL GENERATION SUPPORT METHOD, AND RECORDING MEDIUM

(71) Applicant: NEC CORPORATION, Tokyo (JP)

(72) Inventors: Fumiyo TAKANO, Tokyo (JP); Nobutatsu NAKAMURA, Tokyo (JP); Yuta IDEGUCHI, Tokyo (JP); Dai KUBOTA, Tokyo (JP)

(73) Assignee: NEC CORPORATION, Tokyo (JP)

(21) Appl. No.: 19/143,481

(22) PCT Filed: Jan. 13, 2023
(86) PCT No.: PCT/JP2023/000731

§ 371 Date: Jun. 26, 2025

(51) Int. Cl. G06Q 10/047

(52) U.S. Cl. CPC G06Q 10/047

(57) ABSTRACT

A model generation support system includes: at least one memory storing instructions; and at least one processor configured to execute the instructions to: acquire a model in which an expression is described; identify an intention of the expression described in the model; extract a model template of a different formulation having the same intention as the identified intention from a database that stores model templates of a plurality of formulations for each intention; generate, based on the extracted model template, a model in which an expression based on the different formulation is described; and output the generated model.

### TECHNICAL FIELD

The present disclosure relates to a model generation support system and the like.

### BACKGROUND ART

For example, the combinatorial optimization problem may be solved by a mathematical optimization solver or a quantum computer. In such a case, it is necessary to formulate the constraint conditions and the objective function as a model adapted to the solver. For example, PTL 1 describes preparing a template for an optimization problem in advance, and allowing a user to input parameter values to a plurality of parameters of the template.

### CITATION LIST

### Patent Literature

PTL 1: JP 2021-002331 A

### SUMMARY OF INVENTION

### Technical Problem

In order to perform formulation in generating a model for solving an optimization problem, specialized knowledge is required. In addition, since there are a plurality of types of formulation methods, the user cannot generate a model without knowing each formulation. Therefore, there is a problem that it is difficult for the user to formulate an optimization problem.

An object of the present disclosure is to provide a model generation support system and the like that facilitate formulation of an optimization problem that a user wants to generate.

### Solution to Problem

A model generation support system according to one aspect of the present disclosure includes: an acquisition means for acquiring a model in which an expression is described; an intention identification means for identifying an intention of the expression described in the model; an extraction means for extracting a model template of a different formulation having the same intention as the identified intention from a database that stores model templates of a plurality of formulations for each intention; a generation means for generating, based on the extracted model template, a model in which an expression based on the different formulation is described; and an output control means for outputting the generated model.

A model generation support method according to one aspect of the present disclosure includes: acquiring a model in which an expression is described; identifying an intention of the expression described in the model; extracting a model template of a different formulation having the same intention as the identified intention from a database that stores model templates of a plurality of formulations for each intention; generating, based on the extracted model template, a model in which an expression based on the different formulation is described; and outputting the generated model.

A program according to one aspect of the present disclosure causes a computer to execute a process including: acquiring a model in which an expression is described; identifying an intention of the expression described in the model; extracting a model template of a different formulation having the same intention as the identified intention from a database that stores model templates of a plurality of formulations for each intention; generating, based on the extracted model template, a model in which an expression based on the different formulation is described; and outputting the generated model.

The program may be stored in a non-transitory computer-readable recording medium.

### Advantageous Effects of Invention

According to the present disclosure, it is possible to facilitate formulation of an optimization problem that a user wants to generate.

### BRIEF DESCRIPTION OF DRAWINGS

FIG. 1 is an explanatory diagram illustrating a first example of linear programming formulation of a traveling salesman problem.

FIG. 2 is an explanatory diagram illustrating a second example of linear programming formulation of a traveling salesman problem.

FIG. 3 is an explanatory diagram illustrating an example of a conversion method for handling an integer variable in QUBO.

FIG. 4 is a block diagram illustrating a configuration example of the model generation support system according to a first example embodiment.

FIG. 5 is a flowchart illustrating an operation example of the model generation support system according to the first example embodiment.

FIG. 6 is an explanatory diagram illustrating an example of connection between the model generation support system and a terminal device.

FIG. 7 is a block diagram illustrating a configuration example of the model generation support system according to a second example embodiment.

FIG. 8 is an explanatory diagram illustrating an example in which a model is acquired.

FIG. 9 is an explanatory diagram illustrating an example in which the converted model is popped up.

FIG. 10 is a flowchart illustrating an operation example of the model generation support system according to the second example embodiment.

FIG. 11 is an explanatory diagram illustrating a hardware configuration example of a computer.

### EXAMPLE EMBODIMENT

Hereinafter, example embodiments of a model generation support system, a model generation support method, a program, and a non-transitory recording medium recording the program according to the present disclosure will be described in detail with reference to the drawings. The present example embodiment does not limit the disclosed technology.

Examples where there are a plurality of formulation methods are not particularly limited, but linear programming formulation of a traveling salesman problem, quadratic unconstrained binary optimization (QUBO) formulation of an inequality constraint, and QUBO formulation of integer encoding will be described as examples.

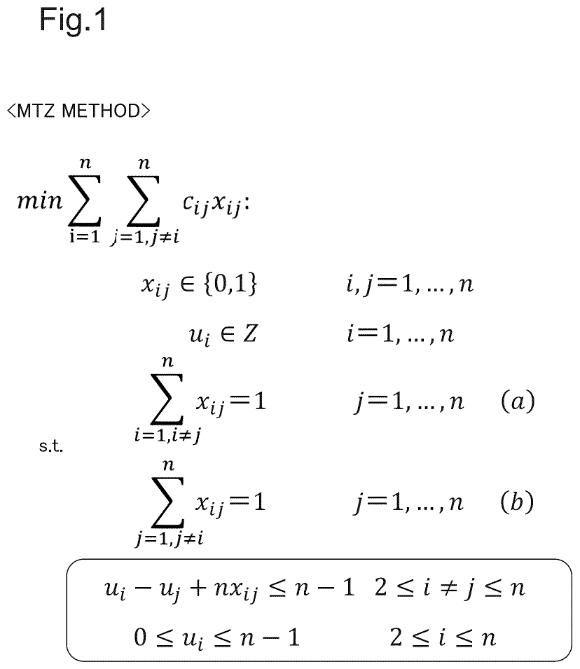

First, the example of linear programming formulation of a traveling salesman problem will be described. The traveling salesman problem is a problem of in what order should one visit cities in order to visit them with a minimum travel distance. FIG. 1 is an explanatory diagram illustrating a first example of linear programming formulation of a traveling salesman problem. In FIG. 1, MILLEER-TUCKER-ZEMLIN (MTZ method) is shown as the linear programming formulation of a traveling salesman problem. In the MTZ method, the number of constraint conditions is small, and the constraint is simple. Therefore, when the MTZ method is used, the user can easily understand the formulation.

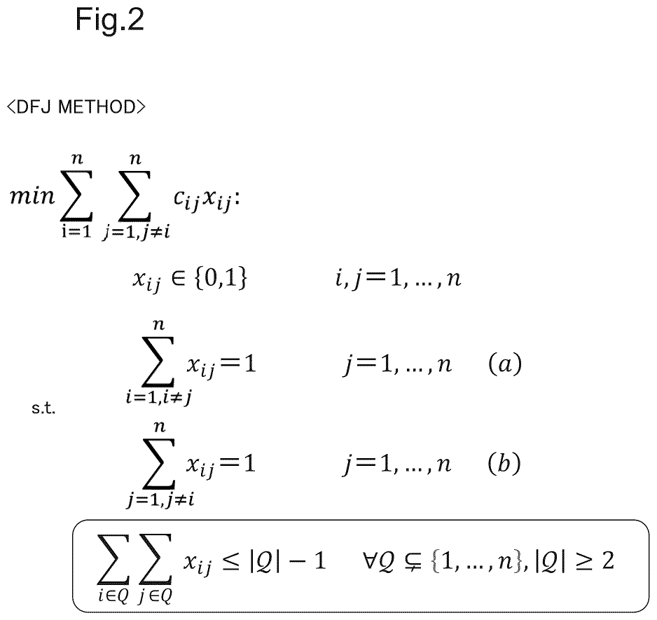

FIG. 2 is an explanatory diagram illustrating a second example of linear programming formulation of a traveling salesman problem. In FIG. 2, the DANTZIG-FULKERSON-JOHONSON (DFJ) method is illustrated as the linear programming formulation of a traveling salesman problem. In the DFJ method, the constraint conditions increase exponentially, but a lower bound value can be easily obtained. That is, the DFJ method often provides high speed.

Next, the QUBO formulation of an inequality constraint will be described. Expression 1 below is an inequality.

$$\sum {w}_{i} {x}_{i} < c \qquad [ Expression 1 ]$$

There are two QUBO formulation methods for the inequality of Expression 1, for example, as shown by Expressions 2 and 3. Expression 2 is a formulation using a slack variable s.

$${( \sum {w}_{i} {x}_{i} + s - c )}^{2} \qquad [ Expression 2 ]$$

$${( \sum {w}_{i} {x}_{{t}^{´}} - \frac{1}{2} c )}^{2} \qquad [ Expression 3 ]$$

Formulation using a slack variable s is accurate, but a large number of variables is required. Expression 3 is a formulation that brings the solution close to a specific value, such as a median value. The specific value is not limited to the median value, and may be any appropriate value. Formulations that bring the solution close to a specific value are less accurate than those using the slack variable s, but still meet an accuracy tolerance and have fewer variables.

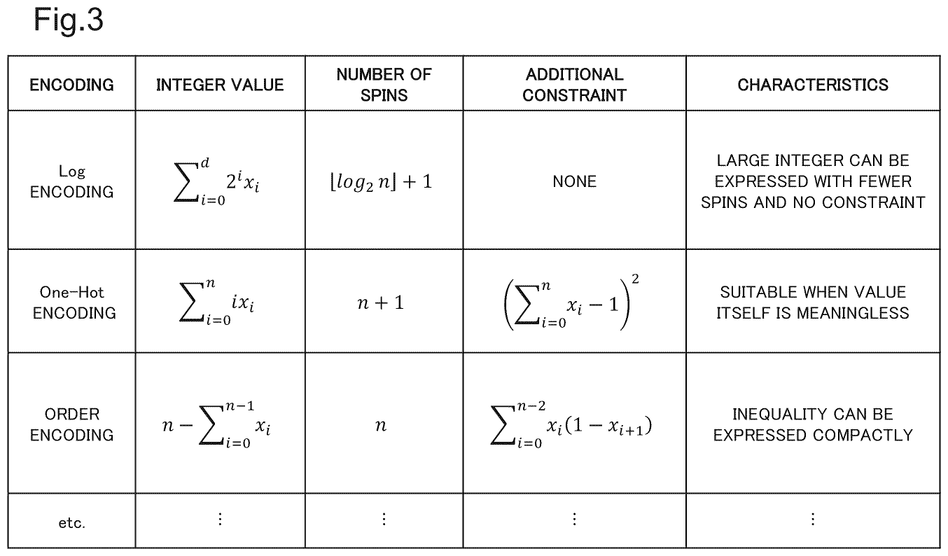

Next, the QUBO formulation of integer encoding will be described. FIG. 3 is an explanatory diagram illustrating an example of a conversion method for handling an integer variable in QUBO. Since only binary variables can be used in QUBO, the variable need to be changed to binary variables for handling integer variables. Examples of conversion methods for handling integer variables in QUBO include log encoding, one-hot encoding, and order encoding. FIG. 3 illustrates the integer value, number of spins, additional constraint, and characteristics of each coding method.

As described above, it can be seen that there are a plurality of formulation methods even for constraint conditions or objective functions having the same intention.

### First Example Embodiment

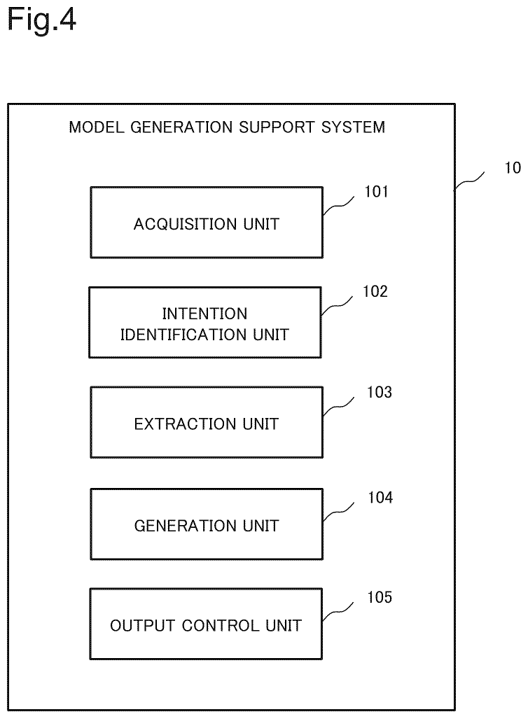

First, in the first example embodiment, a basic function of the control system will be described. FIG. 4 is a block diagram illustrating a configuration example of the model generation support system according to the first example embodiment. This model generation support system 10 includes an acquisition unit 101, an intention identification unit 102, an extraction unit 103, a generation unit 104, and an output control unit 105.

The acquisition unit 101 acquires a model in which an expression is described. The model is a program in which the expression is coded or the expression itself. For example, the acquisition unit 101 may acquire a model input by a user, or may acquire a model via a communication network or the like.

The intention identification unit 102 identifies the intention of the expression described in the model. For example, in a case where the model is a program, the intention identification unit 102 identifies the intention of the expression described in the model by parsing the program. The intention is, for example, a constraint condition or an objective function in a problem that the user wants to solve. More specifically, for example, the intention identification unit 102 extracts a pattern by analyzing the structure of an objective function or constraint expression included in the model. Then, for example, the intention identification unit 102 matches the extracted pattern with each model template included in a database that stores, for each intention, model templates of a plurality of formulations. For example, the database stores a model template for each of the plurality of formulations for each intention. Taking linear programming formulation of the traveling salesman problem as an example, a model template formulated by the MTZ method and a model template formulated by the DFJ method are stored in the database. Based on this, the intention identification unit 102 identifies the intention of the expression described in the model.

From a database that stores model templates of a plurality of formulations individually for the different intentions, the extraction unit 103 extracts a model template of a different formulation having the same intention as the identified intention.

Based on the extracted model template, the generation unit 104 generates a model in which an expression based on the different formulation having the same intention is described. Here, a model in which an expression based on a different formulation is described is also referred to as a converted model. The generation unit 104 may generate a model in which an expression based on a different formulation is described by setting a variable name, the number of possible values of a variable, and a coefficient included in the model template based on at least one of a variable name, the number of possible values of a variable, and a coefficient included in the expression described in the acquired model. For example, the variable name described in the model is n, the variable name included in the model template is d, and the generation unit 104 changes the variable name included in the model template to d. Further, for example, the generation unit 104 may generate a model in which the expression described in the acquired model is replaced with the set model template.

The output control unit 105 presents the generated model to the user. For example, the output control unit 105 outputs the generated model. For example, the output control unit 105 outputs the generated model through a terminal device.

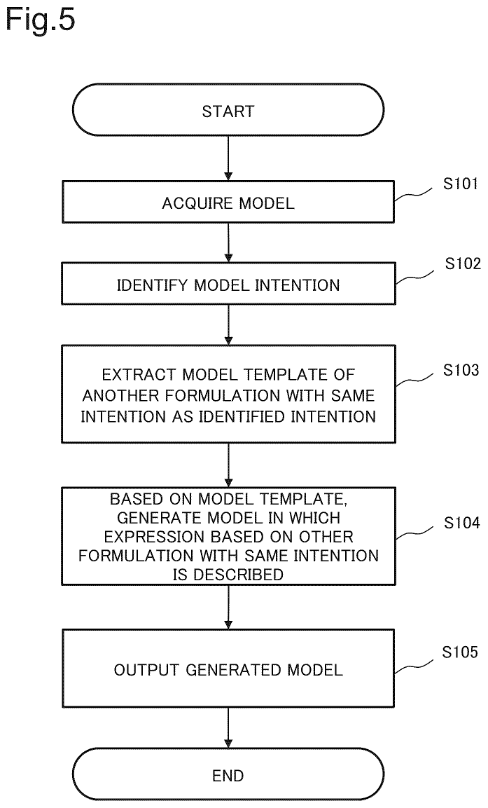

FIG. 5 is a flowchart illustrating an operation example of the model generation support system 10 according to the first example embodiment. The acquisition unit 101 acquires a model (step S101). The intention identification unit 102 analyzes the acquired model to identify the intention of the model (step S102).

Next, the extraction unit 103 extracts a model template of a different formulation having the same intention as the identified intention (step S103). Based on the extracted model template, the generation unit 104 generates a model in which an expression based on the different formulation having the same intention as the expression described in the acquired model is described (step S104). The output control unit 105 outputs the converted model (step S105), and the model generation support system 10 ends the processing.

As described above, there may be a plurality of formulations. However, the user may not know which formulation to choose. It is troublesome for a user to generate a plurality of formulated models. The models cannot be generated if the user does not know each formulation. Therefore, there is a problem that it is difficult for the user to formulate an optimization problem. In the first example embodiment, the model generation support system 10 extracts a model template of a different formulation having the same intention as the intention of the formulation described in a model, generates, based on the extracted model template, a model in which an expression based on the different formulation having the same intention as the intention of the formulation described in the former model is described, and presents the generated model to the user. This facilitates formulation of an optimization problem that the user wants to generate. This in turn saves the user's trouble required for the formulation.

### Second Example Embodiment

Next, a second example embodiment will be described in detail with reference to the drawings. The description of the second example embodiment includes an example in which models before and after conversion are executed to present an optimal model, and an example in which selection of a model is received from a user. Hereinafter, description of content overlapping with the above description will be omitted to the extent that the description of the second example embodiment is not unclear.

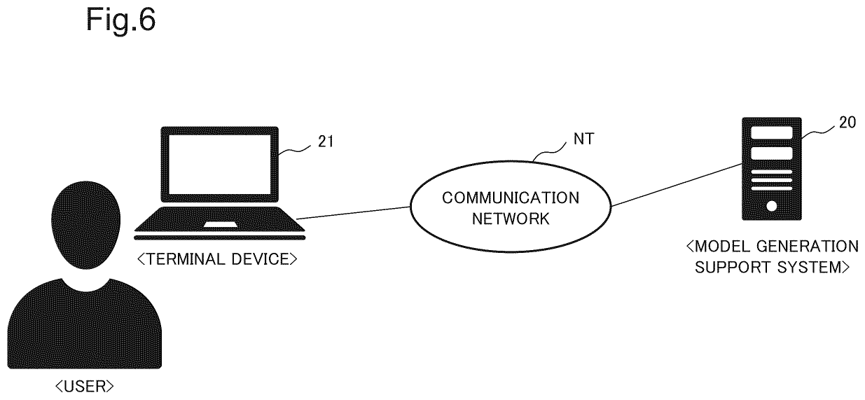

FIG. 6 is an explanatory diagram illustrating an example of connection between the model generation support system and a terminal device. For example, a model generation support system 20 receives an operation made by a user or presents information to the user via a terminal device 21. For example, the model generation support system 20 and the terminal device 21 are connected via a communication network NT.

Here, for example, the model generation support system 20 may be implemented as one function of an editor or an integrated development environment, or may be implemented as a single application program. For example, the terminal device 21 is an application program capable of displaying information from the model generation support system 20. It may be pre-installed with an application program capable of transmitting information to the model generation support system 20. Further, for example, the terminal device 21 may access a webpage of the model generation support system 20 via the communication network NT.

The type of the terminal device 21 is not particularly limited, and may be a personal computer (PC), a smartphone, a tablet device, or the like.

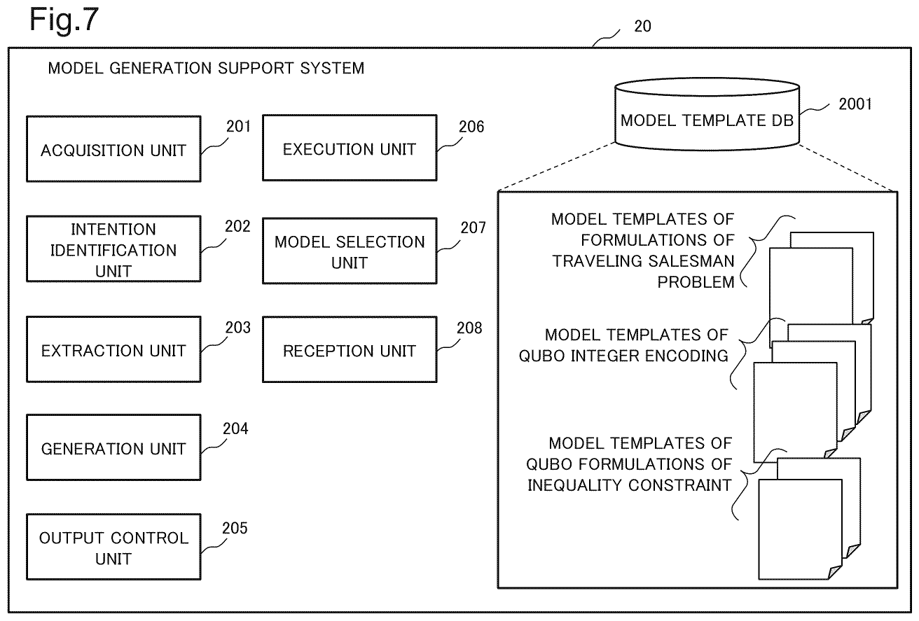

FIG. 7 is a block diagram illustrating a configuration example of the model generation support system 20 according to the second example embodiment. The model generation support system 20 includes an acquisition unit 201, an intention identification unit 202, an extraction unit 203, a generation unit 204, an output control unit 205, an execution unit 206, a model selection unit 207, and a reception unit 208. In addition to the units included in the first example embodiment, the model generation support system 20 includes the execution unit 206, the model selection unit 207, and the reception unit 208.

The acquisition unit 201 has the basic function of the acquisition unit 101 according to the first example embodiment. The intention identification unit 202 has the basic function of the intention identification unit 102 according to the first example embodiment. The extraction unit 203 has the basic function of the extraction unit 103 according to the first example embodiment. The generation unit 204 has the basic function of the generation unit 104 according to the first example embodiment. The output control unit 205 has the basic function of the output control unit 105 according to the first example embodiment.

The model generation support system 20 further includes a model template DB 2001. The model template DB 2001 stores model templates of a plurality of formulations for each intention. In FIG. 7, the model template DB 2001 stores, for example, a plurality of model templates of formulation of traveling salesman problems, a plurality of model templates of QUBO formulation of inequality constraint, and a plurality of model templates of QUBO integer encoding. For example, the model template DB 2001 may associate the stored model templates with identification information for identifying the intention. For example, identification information “001” may identify formulation of traveling salesman problems, identification information “002” may identify QUBO formulation of inequality constraint, and identification information “003” may identify QUBO integer encoding.

The acquisition unit 201 acquires, for example, a model. When the model is a program, for example, the acquisition unit 201 may acquire a model coded by the user via the terminal device 21. For example, the acquisition unit 201 may acquire the model in response to an operation made by the user. Here, an example in which a model is acquired upon compilation will be described.

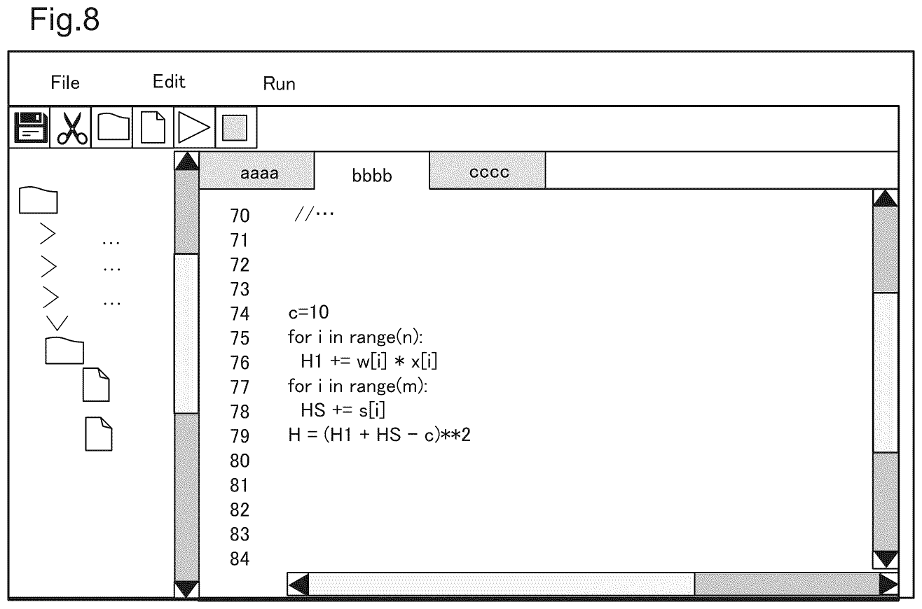

FIG. 8 is an explanatory diagram illustrating an example in which a model is acquired. For example, the acquisition unit 201 acquires a coded model via the terminal device 21. More specifically, for example, the acquisition unit 201 may acquire the model when compilation is instructed. In FIG. 8, as an example, in the model, Expression 2 described above is coded for an inequality.

The intention identification unit 202 parses the acquired model to identify the intention of the model. Then, for example, the intention identification unit 202 may identify the intention of the expression described in the model by matching the expression described in the model with each of the plurality of model templates stored in the model template DB 2001. For example, the intention identification unit 202 identifies the intention of the model template that matches the expression described in the model as the intention of the expression described in the model.

The extraction unit 203 extracts a different model template having the same intention as the identified intention from the model template DB 2001. For example, the extraction unit 203 may extract another model template associated with the same identification information as the identification information that identifies the identified intention from the model template DB 2001. In a case where there are a plurality of formulations other than the formulation of the expression described in the model as in the integer encoding illustrated in FIG. 3, the extraction unit 203 may extract at least one of the plurality of different model templates. For example, the extraction unit 203 may extract a predetermined number of model templates among the plurality of different model templates.

Based on the extracted model template, the generation unit 204 generates a model in which an expression based on the different formulation having the same intention as the expression described in the acquired model is described. For example, the generation unit 204 sets the value of a variable and a constraint condition included in the model template based on the value of a variable and a constraint condition included in the expression described in the acquired model. The generation unit 204 generates a model in which the expression described in the acquired model is replaced with the set model template as a converted model.

The output control unit 205 outputs the converted model.

Specifically, for example, the output control unit 205 may display the converted model on the terminal device 21. Further, the output control unit 205 may display the converted model and the model before conversion in a comparable manner. Specifically, for example, in a case where the acquired model is being displayed on the terminal device 21, the output control unit 205 displays the generated model as a screen different from the screen displaying the acquired model. In other words, displaying the generated model as a screen different from the screen displaying the acquired model means, for example, that the output control unit 205 displays the converted model in a pop-up display while the model before conversion is being displayed.

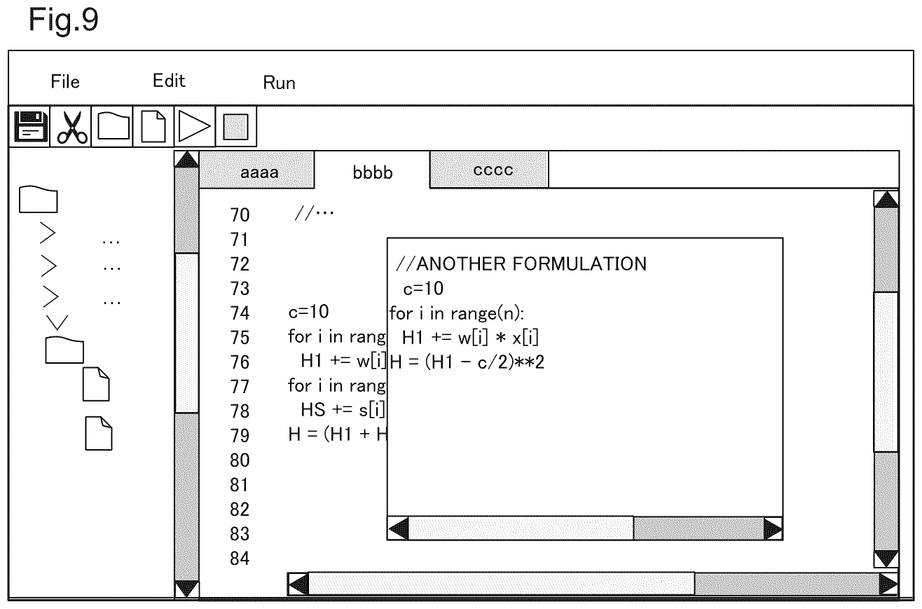

FIG. 9 is an explanatory diagram illustrating an example in which the converted model is popped up. For example, the terminal device 21 superimposes a screen displaying the converted model in which an expression based on a different formulation is described on a screen that is displaying the acquired model and on which the user is working. In FIG. 9, as an example in which an expression based on a different formulation is coded for the inequality, Expression 3 described above is coded in the pop-up converted model. This allows the user to review a plurality of models based on different formulations having the same intention.

Further, for example, when an “apply” button is provided on the screen and the reception unit 208 receives pressing of the “apply” button, the generation unit 204 may reflect the converted model in the acquired model (source code).

In FIG. 9, an example in which the converted model is displayed has been described. For example, the output control unit 205 may display the intention of the expression of the acquired model and information on a different formulation on the terminal device 21. For example, for the expression of the acquired model, a message such as “This part has been determined as an inequality. There is a different formulation for this inequality.” may be displayed together with another mathematical expression.

For example, the reception unit 208 may receive selection of either the model before conversion or the converted model through the user's operation. This allows the user to select the model the user wants to use from models of a plurality of formulations. Then, the execution unit 206 executes the selected model.

The execution unit 206 may execute each of the converted model and the model before conversion. Then, the output control unit 205 may output the execution result for each of the model before conversion and the converted model.

The model selection unit 207 may select a model to be used from the model before conversion and the converted model based on the execution result of the model before conversion and the execution result of the converted model. The selection method is not particularly limited. For example, the model selection unit 207 may select a model that can be executed faster from the model before conversion and the converted model. Alternatively, for example, the model selection unit 207 may select the model having a higher satisfaction rate of the constraint conditions. A plurality of selection methods may be used in combination.

Further, for example, the user may specify which of the execution speed and the satisfaction rate of the constraint conditions is prioritized to select the model. For example, the reception unit 208 receives an instruction as to which of the execution speed and the satisfaction rate of the constraint conditions is to be prioritized in selecting the model. Then, the model selection unit 207 selects a model based on the specified selection method.

The output control unit 205 may present the selected model to the user.

When the execution speed of the model acquired by the acquisition unit 201 does not meet a predetermined speed or when the satisfaction rate of the constraint conditions does not meet a predetermined satisfaction rate, the model generation support system 20 may generate a model of a different formulation having the same intention. For example, the execution unit 206 executes the acquired model. Then, if the execution result of the model does not satisfy a predetermined condition, the intention identification unit 202 identifies the intention of the acquired model. The predetermined condition is, for example, a condition regarding speed or the satisfaction rate of constraint conditions. The extraction unit 203 extracts a different model template having the same intention as the identified intention from the model template DB 2001. Based on the extracted model template, the generation unit 204 generates a model in which an expression based on the different formulation having the same intention as the expression described in the acquired model is described. The output control unit 205 may output the converted model together with information indicating that the execution result of the acquired model does not satisfy the predetermined condition.

The above example describes a case where the generation unit 204 generates a model in which an expression based on a different formulation having the same intention as the expression described in a model is described, and the output control unit 205 presents the generated model. The generation unit 204 sets a variable name, the number of possible values of a variable, and a coefficient included in the extracted model template based on at least one of a variable name, the number of possible values of a variable, and a coefficient included in the expression described in the acquired model. Then, the output control unit 205 may output the set model template.

### (Flowchart)

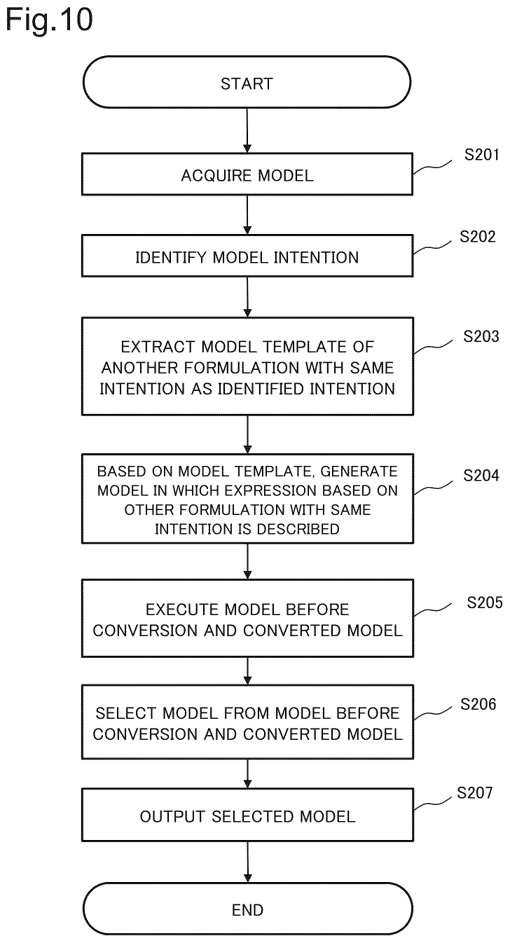

FIG. 10 is a flowchart illustrating an operation example of the model generation support system 20 according to the second example embodiment. The acquisition unit 201 acquires a model (step S201). The intention identification unit 202 analyzes the acquired model to identify the intention of the model (step S202).

Next, the extraction unit 203 extracts a model template of a different formulation having the same intention as the identified intention (step S203). Based on the extracted model template, the generation unit 204 generates a model in which an expression based on the different formulation having the same intention as the expression described in the acquired model is described (step S204).

The execution unit 206 executes each of the converted model and the model before conversion (step S205). Then, the model selection unit 207 select a model from the model before conversion and the converted model based on their execution results (step S206). In step S206, the model selection unit 207 may select, for example, the model that is executed faster. Alternatively, for example, the model selection unit 207 may select the model having a higher satisfaction rate of the constraint conditions. Then, the output control unit 205 outputs the identified model (step S207), and the model generation support system 20 ends the processing.

The model to be acquired has been described above by taking a program as an example, but the model to be acquired may be simply a mathematical expression, and the converted model may be a program in which another mathematical expression having the same intention is coded.

As described above, in the second example embodiment, the model generation support system 20 may identify the intention of an expression described in the model by comparing the expression with the model templates stored in the model template DB 2001. As a result, the intention of the expression can be identified with a simple configuration. This facilitates formulation of optimization problems.

In a case where the acquired model is being displayed on the terminal device 21, the model generation support system 20 displays the generated model as a screen different from the screen displaying the acquired model. By pop-up displaying the generated model in such a manner, the user can easily review a plurality of models of different formulations. This facilitates formulation of optimization problems.

In addition, the model generation support system 20 receives the selection between the acquired model and the generated model through an operation by the user, and executes the selected model. This allows the user to select the model the user wants to use from models of a plurality of formulations. This facilitates formulation of optimization problems.

In addition, the model generation support system 20 executes the acquired model and the generated model, and outputs the selected model based on the execution results. As a result, the user can more easily obtain a model that is more suited to the user's needs.

The description of each example embodiment is ended. The example embodiments may be modified or used in combination as appropriate.

In each example embodiment, the model generation support system 10, 20 may include a portion of the functional units and information.

The example embodiments are not limited to the examples described above, and various modifications can be made. The configurations of the model generation support systems 20 in the example embodiments are not particularly limited. For example, the model generation support systems 10 and 20 may be achieved by one device such as one server. In a case where each functional unit of the model generation support systems 10 and 20 is achieved by one device, for example, one device may be referred to as a model generation support device, an information processing device, or the like, and is not particularly limited. Alternatively, the model generation support systems 10 and 20 in the example embodiments may be achieved by devices different for each function or data. For example, each functional unit may be configured by a plurality of servers and be implemented as the model generation support systems 10 and 20. For example, the model generation support systems 10 and 20 may be achieved by a database server including each database (DB) and a server including each functional unit.

In each example embodiment, each piece of information and each DB may include part of the information described above. Each piece of information and each DB may include information other than the above-described information. Each piece of information or each DB may be divided into a plurality of DBs or a plurality of pieces of information in more detail. As described above, a method of achieving each piece of information and each DB is not particularly limited.

Each screen is an example, and is not particularly limited. In each screen, a button, a list, a checkbox, an information display field, an input field, and the like (not illustrated) may be added. The background color of the screen and the like may be changed.

The processing of generating information or the like to be displayed on the terminal device 21 may be performed by the output control unit 105, 205. This processing may be performed by the terminal device 21.

### (Hardware Configuration Example of Computer)

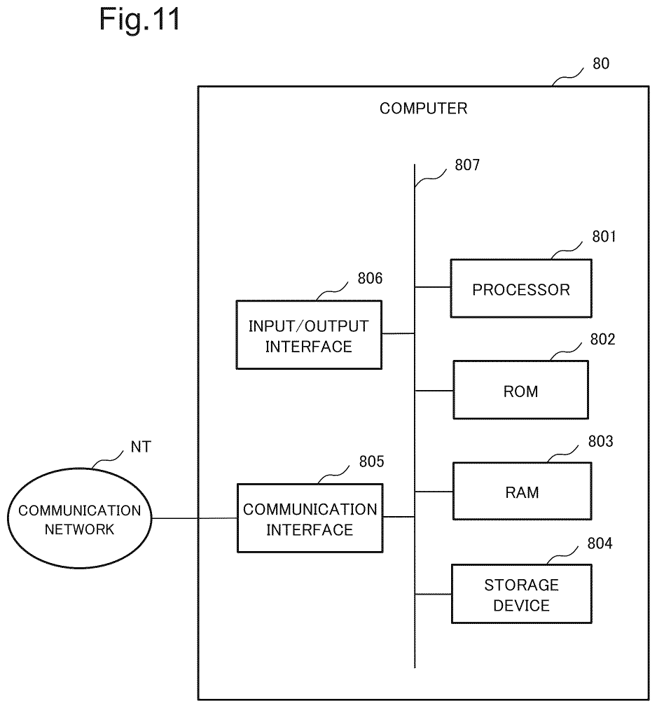

Next, a hardware configuration example in a case where each device such as the model generation support systems 10 and 20 and the terminal device 21 described in each example embodiment is achieved by a computer will be described. FIG. 11 is an explanatory diagram illustrating an exemplary hardware configuration of a computer. For example, part or all of each device can be achieved by using any combination of a computer 80 and the program as illustrated in FIG. 11.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807. The number of each component is not particularly limited, and each component is one or more.

The processor 801 controls the entire computer 80. As the processor 801, for example, a central processing unit (CPU), a digital signal processor (DSP), a graphics processing unit (GPU), a micro processing unit (MPU), a floating point number processing unit (FPU), a physics processing unit (PPU), a tensor processing unit (TPU), a quantum processor, a microcontroller, a combination thereof, or the like can be used. The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each process coded in the program. The processor 801 may download various programs via the communication network NT. The processor 801 functions as part or all of the computer 80. The processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. The communication interface 805 controls an input/output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device, and a sound output device that outputs a sound. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 11. The computer 80 may have components other than those illustrated in FIG. 11. For example, the computer 80 may include a drive device or the like. The processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a display. The computer 80 may include an input device, an output device, and an input/output device.

The computer 80 may include various sensors (not illustrated). The type of the sensor is not particularly limited. The computer 80 may include an imaging device capable of capturing images and videos.

The description of the hardware configuration of each device is ended. There are various modifications in a method of achieving each device. For example, each device may be achieved by any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where part or all of each component of each device is achieved by a plurality of computers, circuits, and the like, the plurality of computers, circuits, and the like may be disposed in a centralized manner or in a distributed manner.

The model generation support method described in each example embodiment is achieved by the model generation support system 20. For example, the model generation support method is achieved by a computer such as a server or the terminal device 21 executing a program prepared in advance.

The program described in each example embodiment is recorded in a computer-readable recording medium such as an HDD, an SSD, a flexible disk, an optical disk, a magnetic optical disk, and a USB memory. The program is executed by being read from the recording medium by the computer. The program may be distributed via the communication network NT.

Each component of the model generation support system 20 in each example embodiment described above may be achieved by dedicated hardware such as a computer. Alternatively, each component may be achieved by software. Alternatively, each component may be achieved by a combination of hardware and software.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

A model generation support system including:
an acquisition means for acquiring a model in which an expression is described;
an intention identification means for identifying an intention of the expression described in the model;
an extraction means for extracting a model template of a different formulation having the same intention as the identified intention from a database that stores model templates of a plurality of formulations for each intention;
a generation means for generating, based on the extracted model template, a model in which an expression based on the different formulation is described; and
an output control means for outputting the generated model.

### (Supplementary Note 2)

The model generation support system according to Supplementary Note 1, wherein the intention identification means identifies the intention of the expression described in the model by comparing the expression described in the model with each of the model templates stored in the database.

### (Supplementary Note 3)

The model generation support system according to Supplementary Note 1 or 2, wherein, when the acquired model is being displayed on a terminal device, the output control means displays the generated model as a screen different from a screen displaying the acquired model.

### (Supplementary Note 4)

The model generation support system according to any one of Supplementary Notes 1 to 3, further including a reception means for receiving selection of any model from the acquired model and the generated model by an operation by a user; and an execution means for executing the selected model.

### (Supplementary Note 5)

The model generation support system according to any one of Supplementary Notes 1 to 4, further including
an execution means for executing each of the acquired model and the generated model,
wherein the output control means outputs a model selected from the acquired model and the generated model based on an execution result from the execution means.

### (Supplementary Note 6)

A model generation support method including:
acquiring a model in which an expression is described;
identifying an intention of the expression described in the model;
extracting a model template of a different formulation having the same intention as the identified intention from a database that stores model templates of a plurality of formulations for each intention;
generating, based on the extracted model template, a model in which an expression based on the different formulation is described; and outputting the generated model.

### (Supplementary Note 7)

A program that causes a computer to execute a process including:
acquiring a model in which an expression is described;
identifying an intention of the expression described in the model;
extracting a model template of a different formulation having the same intention as the identified intention from a database that stores model templates of a plurality of formulations for each intention;
generating, based on the extracted model template, a model in which an expression based on the different formulation is described; and
outputting the generated model.

### (Supplementary Note 8)

A non-transitory computer-readable recording medium that records a program that causes a computer to execute a process including:
acquiring a model in which an expression is described;
identifying an intention of the expression described in the model;
extracting a model template of a different formulation having the same intention as the identified intention from a database that stores model templates of a plurality of formulations for each intention;
generating, based on the extracted model template, a model in which an expression based on the different formulation is described; and
outputting the generated model.

### REFERENCE SIGNS LIST

10, 20 model generation support system
21 terminal device
80 computer
101, 201 acquisition unit
102, 202 intention identification unit
103, 203 extraction unit
104, 204 generation unit
105, 205 output control unit
206 execution unit
207 model selection unit
208 reception unit
801 processor
802 ROM
803 RAM
804 storage device
805 communication interface
806 input/output interface
807 bus
DB 2001 model template
NT communication network

What is claimed is:

1. A model generation support system comprising:
at least one memory storing instructions; and
at least one processor configured to execute the instructions to:
acquire a model in which an expression is described;
identify an intention of the expression described in the model;
extract a model template of a different formulation having the same intention as the identified intention from a database that stores model templates of a plurality of formulations for each intention;
generate, based on the extracted model template, a model in which an expression based on the different formulation is described; and
output the generated model.

2. The model generation support system according to claim 1, wherein the at least one processor is further configured to execute the instructions to:
identify the intention of the expression described in the model by comparing the expression described in the model with each of the model templates stored in the database.

3. The model generation support system according to claim 1, wherein the at least one processor is further configured to execute the instructions to:
display, in a case where the acquired model is being displayed on a terminal device, the generated model on a screen different from a screen displaying the acquired model.

4. The model generation support system according to claim 1, wherein the at least one processor is further configured to execute the instructions to:
receive selection of any model from the acquired model and the generated model by an operation by a user; and
execute the selected model.

5. The model generation support system according to claim 1, wherein the at least one processor is further configured to execute the instructions to:
execute each of the acquired model and the generated model; and
output a model selected from the acquired model and the generated model based on an execution result.

6. A model generation support method comprising:
acquiring a model in which an expression is described;
identifying an intention of the expression described in the model;
extracting a model template of a different formulation having the same intention as the identified intention from a database that stores model templates of a plurality of formulations for each intention;
generating, based on the extracted model template, a model in which an expression based on the different formulation is described; and
outputting the generated model.

7. A non-transitory computer-readable recording medium that records a program that causes a computer to execute a process comprising:
acquiring a model in which an expression is described;
identifying an intention of the expression described in the model;
extracting a model template of a different formulation having the same intention as the identified intention from a database that stores model templates of a plurality of formulations for each intention;
generating, based on the extracted model template, a model in which an expression based on the different formulation is described; and
outputting the generated model.
